(19) United States
(12) Patent Application Publication
(10) Pub. No.: US 2003/0147481 A1
(43) Pub. Date: Aug. 7, 2003

(54) METHOD AND CONTROLLING APPARATUS FOR CONTROLLING AGC UNIT

(76) Inventors: Hung-Kun Chen, Hsinchu (TW); Jui-Hsi Cheng, Hsinchu (TW); Lo-Hsiang Lo, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,362

(22) Filed: Jan. 14, 2003

Related U.S. Application Data
(60) Provisional application No. 60/349,041, filed on Jan. 15, 2002.

(51) Int. Cl. H04L 27/08

(52) U.S. Cl. 375/345

(57) ABSTRACT

The present invention relates to a method and controlling apparatus for controlling AGC unit. The method provided by the present invention first starts to receive a packet. After starting to receive a packet, an average envelope level of a received symbol in the packet is calculated, and a gain of the AGC unit is adjusted for a first time period by looking up the average envelope level in a table to obtain a first adjustment value. After the first time period is past, the method calculates the average envelope level and adjusting the gain of the AGC unit for a second time period by looking up the average envelope level in the table to obtain a second adjustment value. Moreover, the average envelope level is calculated every time after a first duration is past in the first time period, and is calculated every time after a second duration is past in the second time period, and the first duration is different from the second duration.

### CROSS REFERENCE TO RELATED APPLICATIONS

This application claims the priority benefits of U.S. provisional application titled “ADAPTIVE AUTOMATIC GAIN CONTROL FOR INPUT TO ANALOG-TO-DIGITAL CONVERTER” serial No. 60/349,041, filed on Jan. 15, 2002. All disclosures of these applicationsare incorporated herein by reference.

### BACKGROUND OF INVENTION

1. Field of Invention

The present invention relates to a method and controlling apparatus for controlling AGC unit. More particularly, the present invention relates to a method and controlling apparatus for controlling AGC unit in a wireless communication system by using look-up table which records adjustment values of AGC gains corresponding to different signal strength range.

2. Description of Related Art

While communication being more and more important in the world, techniques used in communication system can be roughly divided into two respects, i.e. wired communication and wireless communication.

For wired communication, a channel can be made of twist twin lines, coaxial cable, fiber optics and so on. Whatever the channel is made of, the channel can be basically given as a static model. That is, once a channel is settled, all of its characteristics will be fixed for wired communication. However, on the other hand, wireless communication only uses air as channel. Therefore, the channel used for wireless communication is more unstable than that for wired communication since conditions of air could be various and unpredictable. In other words, air channel introduces different distortions into signals, and most importantly, these distortions are dynamic.

It is therefore important to deal with the dynamic distortions in order to guarantee qualities of received signals. To overcome the challenge, AGC (Automatic Gain Control) mechanism has to be provided. The AGC mechanism provides a receiver the ability to automatically scale the received signal so that the power level of the received signal could be kept stable enough while performing demodulation.

Traditionally, the AGC mechanism is provided by an analog log-amplifier. The log-amplifier comes with two inputs one is the desired threshold and the other is the received signal. After comparing the power ratio of these two inputs, the log-amplifier gives its output as the log of the ratio. In order to increase dynamic range of gain level, most wireless communication devices provide two amplifiers, wherein one of them resides in RF (Radio Frequency) section and is usually a LNA (Low Noise Amplifier) amplifier, and the other one resides in IF (Intermediate Frequency)/baseband section and is usually a VGA (Variable Gain Amplifier) amplifier. The available gain levels of the LNA are discrete, for example, the LNA usually has two gain levels, 0 dB and G _{LNA} dB, where G _{LNA} is usually around 30 dB. The gain level of the VGA is continuous and the dynamic range is usually around 70 dB.

However, the AGC mechanism described above exhibits a relatively slow attack time and is lack of flexibilities. Therefore, a new AGC mechanism which employs digital baseband control technique is disclosed as in U.S. Pat. No. 6,038,435, named “Variable Step-Size AGC”, which is corporate herewith as reference. The digital baseband control uses received baseband signal to determine an appropriate gain level, and can simultaneously adjust gain in RF and IF/baseband domains. However, while the digital baseband control method provides a better flexibility, there still some other extra issues need to be resolved.

The first issue which needs to be resolved is signal limiting, which represents the situation that the input signal amplitude exceeds the working range of an ADC (Analog to Digital Converter) in the AGC mechanism and therefore results in the phenomenon that the output signal amplitude will saturate at the maximum or minimum representable value of the ADC. In other words, once the received signal passing ADC has been saturated, little information can be used to justify the gain.

Another issue which needs to be resolved is signal delay due to the ADC. Generally, a processing time is needed for an ADC to perform sampling and quantizing the input analog signal into a digital signal, and therefore the AGC mechanism has a response delay. Depending on qualities and structures of ADC, this latency may significantly affect performance of baseband AGC.

Accordingly, an AGC mechanism that can solve the issues described above is necessary for wireless communication system.

### SUMMARY OF INVENTION

The invention provides a method and controlling apparatus for controlling an AGC unit in a wireless communication system to reduce probabilities of occurrence of signal limiting.

As embodied and broadly described herein, the present invention provides a method for operating an AGC unit. The method provided by the present invention first starts to receive a packet. After starting to receive a packet, an average envelope level of a received symbol in the packet is calculated, and a gain of the AGC unit is adjusted for a first time period by looking up the average envelope level in a table to obtain a first adjustment value. After the first time period is past, the method calculates the average envelope level and adjusting the gain of the AGC unit for a second time period by looking up the average envelope level in the table to obtain a second adjustment value. Moreover, in the present invention, the average envelope level is calculated every time after a first duration is past in the first time period, and is calculated every time after a second duration is past in the second time period, and the first duration is different from the second duration.

In one embodiment, the present invention sets the gain to be a maximum value before it is adjusted, and the first time period starts after the gain is decreased to or below a preset high threshold. In a further embodiment, the gain is locked after the second time period is past.

Furthermore, the present invention provides a method for operating an AGC unit, which is characterized in adjusting a gain of the AGC unit in each of a plurality of time periods by comparing an envelope level of a received symbol with a plurality of stages occurred for different frequencies and selecting an adjustment value according to a comparing result.

Moreover, the present invention provides a controlling apparatus for controlling an AGC unit. The controlling apparatus includes a storage device and a control unit, wherein the storage device stores a table containing a plurality of ranges and a plurality of adjustment values that each of the ranges relates to one of the adjustment values, and the control unit looks up an envelope level of a received symbol into the storage device and then obtains one of the adjustment values corresponding to one of the ranges containing the envelope level, and adjusts a gain of the AGC unit by using the obtained adjustment value.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a block diagram which shows an AGC architecture comprising an AGC controlling apparatus according to one embodiment of the present invention;

FIG. 2 illustrates a timing diagram which describes the operation method according to the embodiment shown in FIG. 1;

FIG. 3 illustrates a flow chart according to another embodiment of the present invention; and

FIG. 4 illustrates a simulation curve which shows the effect of one embodiment of the present invention.

### DETAILED DESCRIPTION

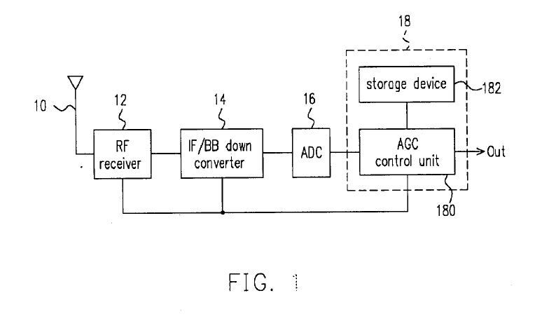

Referring to FIG. 1, which illustrates a block diagram showing an AGC architecture comprising an AGC controlling apparatus according to one embodiment of the present invention. In the embodiment, RF (Radio Frequency) receiver 12 receives packets of symbols from antenna 10 and then supplies its output signal to the IF (Intermediate Frequency)/BB (Base Band) down converter 14. The IF/BB down converter 14 supplies its output signals to the ADC 16 in order to produce digitized samples which are coupled to the AGC controlling apparatus 18. Without loss of generality, we assume that there are M, e.g. M=22, samples during a symbol duration. By measuring the strength of the samples, the AGC controlling apparatus 18 calculates an AGC gain, which may, depending on the stage of AGC mechanism, be used firstly to set the gain of LNA (Low Noise Amplifier) (not shown) in RF receiver 12, then secondly to set the gain of VGA (Variable Gain Amplifier) (not shown) in IF/BB down converter 14, according to the digitized signal. Take AGC gain of 40 dB and the two gain levels of LNA are 0 and 30 dB as an example, the LNA's gain will be set to 30 dB, and the VG's gain will be set to 10 dB. Take AGC gain of 20 dB as another example, the LNA's gain will be set to 0 dB, and the VGA's gain will be set to 20 dB.

As shown in FIG. 1, the controlling apparatus 18 in the embodiment includes an AGC control unit 180 and a storage device 182. The storage device 182 stores a table of strength ranges versus adjustment values. Here, the strength could represent the average envelope or the average power of the samples. However, in order to ease the description, we hereafter let strength represent the average envelope level. The control unit 180 looks up an average envelope level of M ₁, which is an integer, received samples into the storage device 182 and then obtains one of the adjustment values corresponding to the ranges containing the average envelope level in order to adjust the gain of the AGC unit by using the obtained adjustment value.

For example, as shown in Table 1 below, an average envelope level calculated from the received samples having envelope range (0,1.42) is used as an index in order to choose one of the ranges listed in Table 1 and to obtain the corresponding adjustment value for adjusting the gain of the AGC unit.

TABLE 1

| Range | Gain Adjustment Value (dB) |
|---|---|
| 1.30˜ | −27 |
| 1.16˜1.30 | −8 |
| 1.03˜1.16 | −7 |
| 0.92˜1.03 | −6 |
| 0.82˜0.92 | −5 |
| 0.73˜0.82 | −4 |
| 0.65˜0.73 | −3 |
| 0.58˜0.65 | −2 |
| 0.52˜0.58 | −1 |
| 0.46˜0.52 | 0 |
| 0.41˜0.46 | 1 |
| 0.37˜0.41 | 2 |
| 0.33˜0.37 | 3 |
| 0.29˜0.33 | 4 |
| 0.26˜0.29 | 5 |
| 0.23˜0.26 | 6 |
| 0.21˜0.23 | 7 |
| 0.18˜0.21 | 8 |
| 0.16˜0.18 | 9 |
| 0.15˜0.16 | 10 |
| 0˜0.15 | 27 |

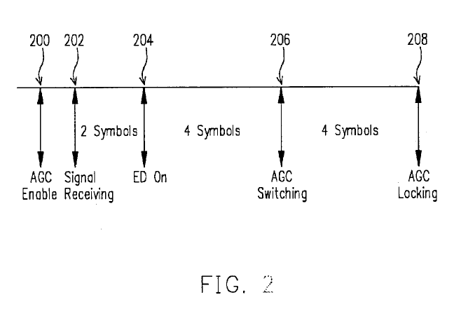

Referring to FIG. 1 and FIG. 2, wherein FIG. 2 illustrates a timing diagram which describes the operation method according to the embodiment shown in FIG. 1. As shown in FIG. 2, the AGC unit enables and starts to measure the average envelope level of the received samples at time point 200. The gain of the AGC unit, as well as the gain the LNA and VGA amplifies, are initially set to be a maximum values in order to effectively detect a signal, and the gains of the LNA and VGA will be adjusted according to the gain of the AGC unit after the average envelope level of the received samples is high enough. To speak more specifically, the gain of the AGC unit is maximum at beginning and will be decreases by the AGC algorithm once the envelope level of the received samples becomes increasing. An energy detect (ED) indicator will be on once the gain of the AGC unit decreases below a certain threshold value, named ED-ON level. Hereinafter, the ED-ON level is configured as high threshold of energy detect level.

Referring now back to FIG. 2, assuming that the signal appears at time point 202, it is assumed that the envelope level of the received signal increases to the ED-ON level after several symbol durations are past. Therefore, the ED is turned on at time point 204. After turning on the ED, the gains of the LNA and VGA are adjusted based on the gain of the AGC unit during a first time period, for example, time needed for analyzing 4 symbols in the embodiment. This stage is referred as macro adjustment stage hereinafter. Moreover, in the embodiment, the average envelope level of the received samples is measured over N ₁, i.e. N ₁=M/2=11, samples and used to obtain an adjustment value according to a preset table of envelope range versus adjustment value stored in the storage device 182. The gain of AGC unit is then be adjusted according to the adjustment value. The gains of the LNA and VGA are in turn adjusted based on the updated gain of AGC unit.

After the macro adjustment stage ends at time point 206, the gain adjustment switches into another stage, named micro adjustment stage. In the micro adjustment stage, the gains of the AGC unit, LNA and VGA are adjusted in the same way as in the micro adjustment stage. However, in the micro adjustment stage, the average envelope level of the received samples is measured over N ₂, i.e. N ₂=M=22, samples and used to obtain the adjustment value according to the preset table of envelope range versus adjustment value stored in the storage device 182.

After the micro adjustment stage ending at time point 208, the gains of LNA and VGA are locked. However, the present invention still keeps calculating the gain of the AGC unit. That is, although the gains of LNA and VGA are locked, the gain of the AGC unit is still adjusted during the period after time point 208.

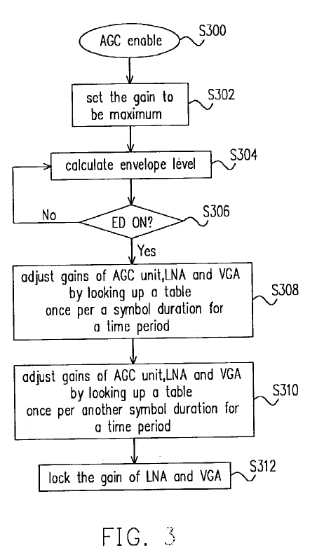

An embodiment which shows another aspect of the present invention is illustrated in FIG. 3, which is a flow chart according to one embodiment of the present invention.

In this embodiment, the AGC enables in step S300, and the gains of the AGC unit, LNA and VGA are set to be its maximum value in step S302. Thereafter, the AGC starts to calculate the envelope level occurred on its input signal line in step S304. If the envelope level of a received symbol turns the ED on in step S306 as described in the former embodiment, the flow proceeds to step S308, otherwise the step S304 and S306 are repeatedly performed.

After the ED is turned on, the embodiment performs step S308 to adjust the gain by looking up a table, which stores a plurality of stages with several ranges, that each adjustment occurs after a duration, for example, 11 samples in the former embodiment, being past for a time period. Thereafter, the embodiment performs step S310 to adjust the gain by looking up the same table that each adjustment occurs after another one duration, for example, 22 samples in the former embodiment, being past for another time period.

Furthermore, the time period that performs step S308, S310 or even more other gain adjustment stages can be either the same or different from each other. In a preferred embodiment according to the present invention, the time periods last 2 to 6 symbols. However, the time period can be defined by using adjusting times so that in another preferred embodiment according to the present invention, the gain is adjusted for 4 to 12 times in the first time period and adjusted for 2 to 6 times in the second time period.

After adjusting the gain in those time period, the present invention locks the gains of the LNA and VGA in step S312. However, as described before, although the gains of the LNA and VGA are locked, the gain of the AGC unit can still be calculated by the method mentioned above.

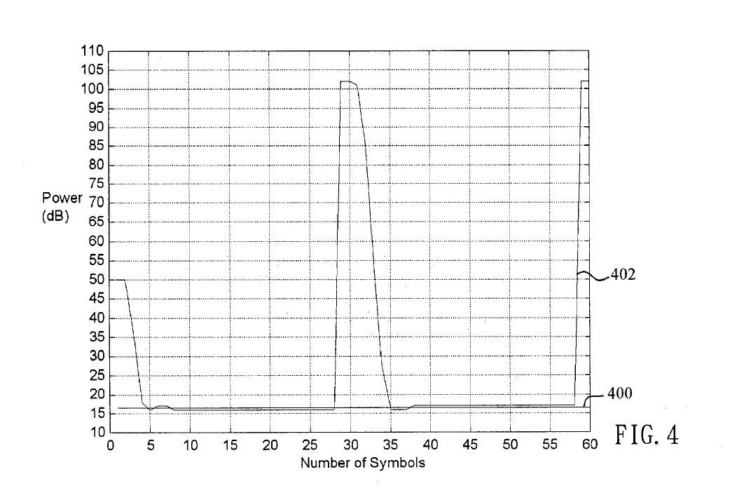

The simulation result of the method described above is shown in FIG. 4, wherein the curve 400 represents a desired gain level, and the curve 402 represents a gain curve of the AGC unit according to the method. It is obviously that the gain level can be locked to the desired gain level in about 8 symbols (28 35). Therefore, the present invention provides a good approach in fast responding to the incoming signals.

In conclusion, the present invention has the following advantages:

1. The present invention provides an approach in fast responding to the incoming signals; and

2. The present invention provides an approach to decrease the probability of ADC saturation occurrence.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for controlling the amplitude of the input to an analog to digital converter, the method comprising:
receiving a digital signal from the analog to digital converter;
periodically measuring an average level of the digital signal;
calculating a preliminary gain value according to the average signal level;
generating gain control signals according to the preliminary gain value during a first and second time period; and
controlling the amplitude of the input to the analog to digital converter with the gain control signals during the first and second time period;
wherein the first time period starts after the preliminary gain value is below a threshold, and the second time period starts right after the first time period.

2. The method of claim 1, wherein the preliminary gain value is initially set to a maximalavailable value.

3. The method of claim 1, wherein the average signal level is measured periodically over a block of digital signal, wherein the period is the duration of the digital signal block, the block size is initially set to be a first number, the block size is set to the first number during the first time period, and the block size is set to a second number after the first time period.

4. The method of claim 3, wherein the second number is larger than the first number.

5. The method of claim 3, wherein the average signal level is obtained by measuring the average power over a block of digital signal.

6. The method of claim 3, wherein the average signal level is obtained by measuring the average envelop over a block of digital signal.

7. The method of claim 1, wherein calculating the preliminary gain value further comprises:
using the average signal level to lookup a gain adjustment value from a table;
wherein the table is a table of signal level range versus the gain adjustment value; and
adjusting thepreliminary gain value with the gain adjustment value.

8. The method of claim 1, wherein generating gain control signals further comprises:
calculating a first gain value as a first gain control signal according to the preliminary gain value; and
calculating a second gain value as a second gain control signal according to the preliminary gain value and the first gain value.

9. The method of claim 1, wherein controlling the amplitude of the input to the analog to digital converter further comprises:
controlling the gain of a low noise amplifier with the first gain control signal, wherein the low noise amplifier is connected in the signal flow to the analog to digital converter; and
controlling the gain of a variable gain amplifier with the second gain control signal, wherein the variable gain amplifier is connected in the signal flow to the analog to digital converter.

10. The method of claim 1, further comprising locking the amplitude of the input to the analog to digital converter after the second time period.

11. An apparatus for controlling the amplitude of the input to an analog to digital converter, the apparatus comprising:
a storage device, which stores a table of signal level range versus the gain adjustment value;
a control unit, coupled to the storage device and the analog to digital converter, to generate a first and second gain control signal;
a first gain control line, connected to the control unit and a low noise amplifier, carries the first gain control signal; and
a second gain control line, connected to the control unit and a variable gain amplifier, carries the second gain control signal; wherein
the low noise amplifier and variable gain amplifier are connected in the signal flow to the analog to digital converter.

12. The apparatus of claim 11, wherein the control unit comprises:
an average signal level measurer, coupled to the output of the analog to digital converter, for periodically measuring an average level of the output digital signal of the analog to digital converter;
a preliminary gain value calculator, coupled to the average signal level measurer and the storage device, for calculating a preliminary gain value;
a gain control signal generator coupled to the preliminary gain value calculator,
wherein the gain control signal generator generates gain control signals according to the preliminary gain value during a first and second time period.

13. The apparatus of claim 12, wherein the average signal level measurer measures the average signal lever over a block of digital signal, wherein the period is the duration of the digital signal block, the block size is initially set to be a first number, the block size is set to the first number during the first time period, and the block size is set to a second number after the first time period.

14. The method of claim 13, wherein the second number is larger than the first number.

15. The method of claim 13, wherein the average signal level measurer obtains the average signal level by measuring the average power over a block of digital signal.

16. The method of claim 13, wherein the average signal level measurer obtains the average signal level by measuring the average envelope over a block of digital signal.

17. The method of claim 12, wherein the preliminary gain value calculator uses the average signal level to lookup a gain adjustment value from a table stored in the storage device, and adjusts thepreliminary gain value with the gain adjustment value.

18. The method of claim 12, wherein the gain control signal generator calculates a first gain value as a first gain control signal according to the preliminary gain value, and calculates a second gain value as a second gain control signal according to the preliminary gain value and the first gain value.

19. The method of claim 18, wherein the gain control signal generator locks the first and second gain value after the second time period.
